(19) United States
(12) Patent Application Publication
(10) Pub. No.: US 2026/0316294 A1
(43) Pub. Date: Oct. 15, 2026

(54) Gripping Apparatus And Method For Determining Gripping State

(71) Applicant: NOK CORPORATION, Tokyo (JP)

(72) Inventors: Kou TEI, Fujisawa (JP); Noriyuki GOTO, Fujisawa (JP)

(21) Appl. No.: 19/704,905

(22) Filed: Jun. 11, 2026

Related U.S. Application Data
(63) Continuation of application No. PCT/JP2025/017243, filed on May 12, 2025.

(30) Foreign Application Priority Data
Aug. 29, 2024 (JP) 2024-147903

(51) Int. Cl. B25J 15/00; B25J 9/16

(52) U.S. Cl. CPC B25J 15/0023; B25J 9/1694

(57) ABSTRACT

A gripping apparatus for gripping an article includes a drive, a support operable by the drive, a detector that detects a voltage, a bag attached to the support, a mixture contained in the bag and including particles and a fluid, and a pressure regulator that regulates a pressure of the fluid contained in the bag while maintaining a shape of the bag. The bag is formed from an elastomer and is elastically deformable in conformance with a shape of the article. The bag senses a contact pressure resulting from contact with the article to output a voltage to the detector.

### CROSS-REFERENCE TO RELATED APPLICATIONS

This application is a continuation application of PCT International Application No. PCT/JP2025/017243, filed on May 12, 2025, which claims the priority benefit of Japanese Patent Application No. 2024-147903, filed on Aug. 29, 2024, the entire contents of which are hereby incorporated by reference.

### BACKGROUND

### 1. Technical Field

The present invention relates to a gripping apparatus and a method for determining a gripping state.

### 2. Description of the Background

A known gripping apparatus including a gripper using the jamming transition is described in Japanese Unexamined Patent Application Publication No. 2013-523478 (hereafter, Patent Literature 1). The apparatus described in Patent Literature 1 is a passive gripping and releasing apparatus including a deformable membrane having an opening fluidically coupled to a source serving as a fluid inlet and a fluid outlet in a dischargeable sealing relationship, at least one port providing the source serving as a fluid inlet and a fluid outlet fluidically connected the opening of the membrane, and a granular material in the membrane.

### BRIEF SUMMARY

A gripper using the jamming transition includes a bag (corresponding to the membrane in Patent Literature 1) containing a fluid-like mixture (corresponding to the granular material in Patent Literature 1) and having a surface into which an article as a gripping target is pressed to be embedded. The surface of the bag elastically deforms into a shape conforming to the outer shape of the article. The gripper elastically deforming to receive the embedded article causes the mixture in the bag to transition from a fluid-like state to a solid-like state and is thus in a gripping state in which the gripper can grip the article and perform transferring such as handling. Such a gripper using the jamming transition and elastically deformable with a bag receiving an embedded article is elastically deformable into appropriate shapes to grip various articles with different outer shapes using the bag in one form.

In a gripping apparatus including a manipulator that uses multiple actuators to grip an article, a mechanical apparatus such as a push button is used as one known method for determining the gripping state of the manipulator. The mechanical apparatus is attached to the manipulator. The mechanical apparatus outputs a voltage when in contact with the article. The gripping apparatus including the manipulator determines the gripping state of the manipulator based on a detection result of the voltage that is output from the mechanical apparatus in contact with the article. However, when the mechanical apparatus is attached to a bag in a gripper using the jamming transition, the bag may not deform into a shape appropriate for gripping an article because of the rigidity of the mechanical apparatus. An optical device such as a camera may be used as a method for determining the gripping state of the gripper using the jamming transition. In this case, a determination system using the method has a more complex structure than a structure that uses the mechanical apparatus.

One aspect of the present disclosure is directed to a gripping apparatus using the jamming transition to grip an article with a bag that can determine the gripping state for the article with a simple structure.

One aspect of the present disclosure is directed to a method for determining the gripping state with a simple structure when a bag using the jamming transition grips an article.

An aspect of the present disclosure provides a gripping apparatus for gripping an article, the apparatus including:
a drive;
a support operable by the drive;
a detector configured to detect a voltage;
a bag attached to the support, the bag comprising an elastomer and being elastically deformable in conformance with an outer shape of the article, the bag being configured to sense a contact pressure resulting from contact with the article to output a voltage to the detector;
a mixture contained in the bag, the mixture comprising particles and a fluid; and
a pressure regulator configured to regulate a pressure of the fluid contained in the bag while maintaining a shape of the bag.

Another aspect of the present disclosure provides a method for determining a gripping state, the method including:
causing a bag to come in contact with an article and to deform elastically while conforming to an outer shape of the article in an adhering state and output a voltage, the bag containing a mixture of particles and a fluid, the bag containing a predetermined amount of the fluid;
reducing a pressure of the mixture while maintaining the adhering state of the bag to cause a jamming transition of the mixture and cause a shift of the bag from a softened state to a hardened state to grip the article;
storing, as a reference value, a value of a voltage output from the bag when the bag shifts from the softened state to the hardened state; and
determining a gripping state of the bag based on whether a difference between a value of a voltage output from the bag in the hardened state and the reference value exceeds a predetermined threshold.

The gripping apparatus according to the above aspect of the present disclosure can provide a gripping apparatus using the jamming transition to grip an article with a bag that can determine the gripping state for the article with a simple structure.

The method for determining the gripping state according to the above aspect of the present disclosure can provide a method for determining the gripping state with a simple structure when a bag using the jamming transition grips an article.

### BRIEF DESCRIPTION OF DRAWINGS

FIG. 1 is a schematic diagram of a gripping apparatus according to an embodiment.

FIG. 2 is a block diagram of the gripping apparatus according to the embodiment.

FIG. 3 is a schematic diagram of a gripping apparatus according to a modification.

FIG. 4 is a schematic diagram of the gripping apparatus according to the modification.

FIG. 5 is a schematic diagram of the gripping apparatus according to the embodiment before gripping an article.

FIG. 6 is a schematic diagram of the gripping apparatus according to the embodiment gripping the article.

FIG. 7 is a schematic diagram of the gripping apparatus according to the embodiment gripping the article and being apart from a table.

FIG. 8 is a schematic diagram of the gripping apparatus according to the embodiment after dropping the article.

FIG. 9 is a flowchart of a method for determining the gripping state according to an embodiment.

### DETAILED DESCRIPTION

One or more embodiments of the present disclosure will be described below with reference to the drawings. The drawings may not be precisely drawn to scale, and one or more features may be exaggerated or not shown.

The vertical direction (the direction of gravity) is hereafter referred to as the X-direction. A vertically upward direction is referred to as the positive X-direction. A vertically downward direction is referred to as the negative X-direction.

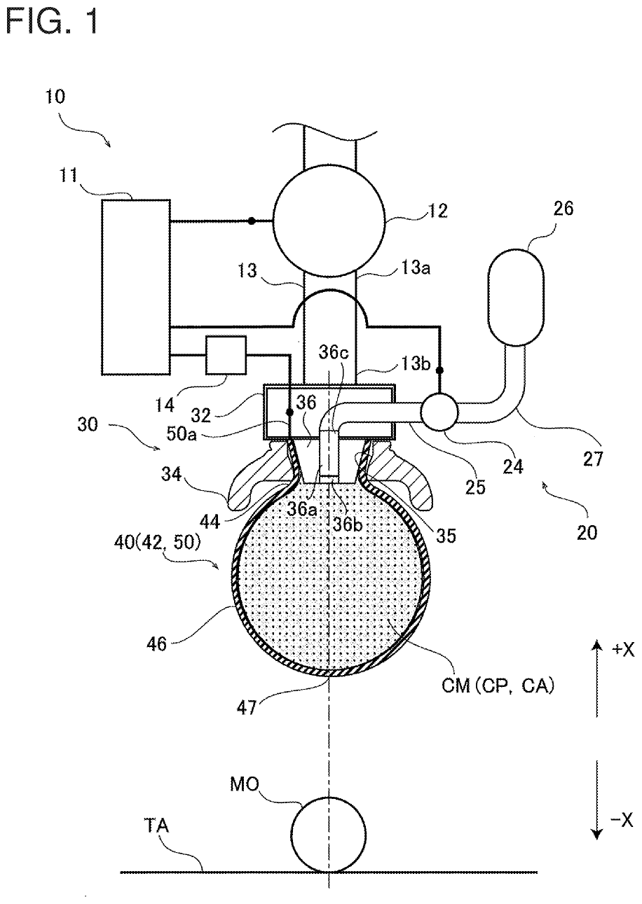

A gripping apparatus 10 according to one or more embodiments of the present disclosure is, as shown in FIG. 1, an articulated robot that can perform a handling operation of gripping an article MO placed on a table TA and transferring the article MO to a destination table (not shown).

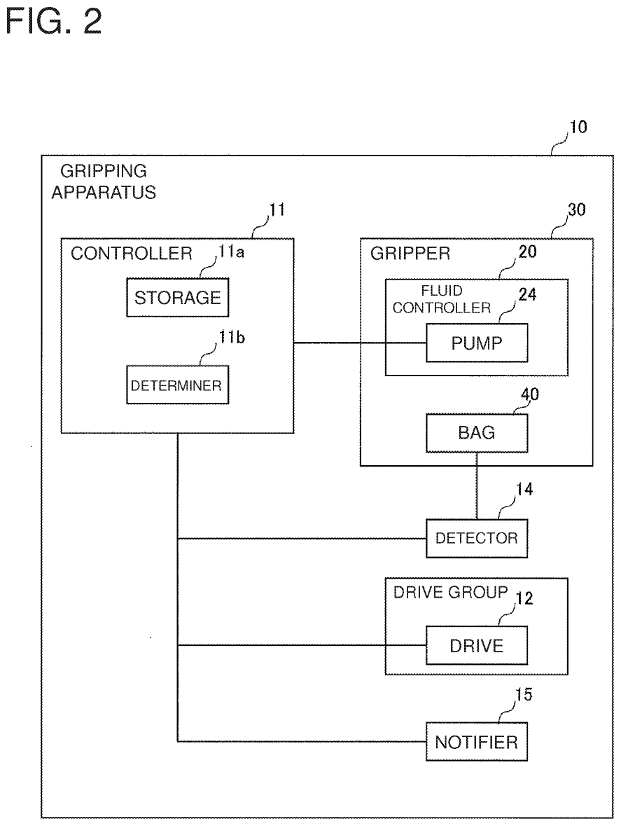

The gripping apparatus 10 includes a drive 12, a support 13, a gripper 30, a detector 14, and a controller 11 as shown in FIG. 1. The gripping apparatus 10 further includes a notifier 15 as shown in FIG. 2.

The drive 12 in the embodiment includes a motor and a gearbox (not shown). The drive in one or more embodiments of the present disclosure may include a linear actuator. The motor in the drive 12 operates under control of the controller 11.

The support 13 is a column extending in one direction. The support 13 includes a first end 13a and a second end 13b. The first end 13a is coupled to the drive 12. The second end 13b is opposite to the first end 13a. The support 13 is operable by the drive 12.

In the gripping apparatus 10 according to the embodiment, the drive 12 is further coupled to another support and another drive (not shown).

The gripper 30 is coupled to the second end 13b as shown in FIG. 1. The gripper 30 can grip the article MO. The gripper 30 will be described in detail later.

The detector 14 detects a voltage that is output from the gripper 30. The detector 14 can transmit the value of the detected voltage to the controller 11.

The notifier 15 provides a notification indicating the state of the gripping apparatus 10. The notifier 15 is, for example, a display monitor. The notifier 15 may be a revolving light. The notifier 15 may have a sound output function.

The controller 11 controls the components of the gripping apparatus 10. More specifically, the controller 11 controls a drive group, the notifier 15, and the operation of the gripper 30 as shown in FIG. 2. The drive group includes multiple drives including the drive 12. The gripping apparatus 10 is operable to move the gripper 30 toward the article MO with the controller 11 controlling the drive group. The controller 11 will be described in detail later.

### Gripper 30

The gripper 30 includes a base 32, a cover 34, a bag 40, a mixture CM, a plug 36, and a fluid controller 20 as shown in FIG. 1.

The base 32 is a box. The base 32 is coupled to the second end 13b of the support 13. In the embodiment, a surface of the base 32 facing the second end 13b is coupled to the second end 13b. The base 32 supports the components of the gripper 30. The base 32 can contain the components of the gripper 30. The base 32 in the embodiment can contain a terminal 50a, a port 36a, and a pipe 25 (described later).

The cover 34 is attached to a surface of the base 32 facing in a direction different from a direction toward the support 13. The cover 34 in the embodiment is attached to a surface of the base 32 facing a position opposite to the second end 13b of the support 13. The cover 34 is a bowl that is open toward a position opposite to the base 32. The cover 34 has a hole 35. The hole 35 extends through the cover 34 along the central axis of the cover 34. An outer surface of a neck 44 of the bag 40 (described later) is supported in the hole 35. A receiving portion 46 of the bag 40 is exposed from the cover 34 through the opening of the cover 34 that is a bowl. The bag 40 supported by the cover 34 thus has an outer shape of a round bottom container that is narrower in the neck 44. The cover 34 protects the bag 40 around the neck 44.

The plug 36 is cylindrical. The plug 36 is in contact with the inner surface of the neck 44 of the bag 40. The plug 36 has a cylindrical side surface sealing the inner surface of the neck 44 supported by the hole 35. The plug 36 in the embodiment is located in the neck 44 and fastened to the cover 34 or the base 32 with a coupling member (not shown) including a bolt.

The plug 36 includes a port 36a. The port 36a is a tube through which a fluid CA can pass between the inside (the receiving portion 46 described later) of the bag 40 sealed with the plug 36 and the outside of the bag 40. The port 36a includes a filter 36b and a connection end 36c.

The filter 36b is at an end of the port 36a facing the receiving portion 46 of the bag 40. The filter 36b allows the fluid CA to pass. The filter 36b blocks the particle CP from passing.

The connection end 36c is an end of the port 36a opposite to the filter 36b. The connection end 36c is connected to the pipe 25 of the fluid controller 20 (described later).

The fluid controller 20 controls the amount of the fluid CA that is contained in the bag 40 through the port 36a. The fluid controller 20 regulates the pressure of the fluid CA contained in the bag 40. In other words, the fluid controller 20 regulates the pressure inside the bag 40. The fluid controller 20 is an example of a pressure regulator. The fluid controller 20 can evacuate the bag 40 to a vacuum.

The fluid controller 20 includes a pump 24, the pipe 25, a tank 26, and a pipe 27.

The pump 24 causes the fluid CA to, through a pipe connected to the pump 24, flow out of or into a component connected to the pipe. The operation of the pump 24 is controlled by the controller 11.

In other words, the operation of the fluid controller 20 is controlled by the controller 11.

The pipe 25 connects the port 36a and the pump 24 between which the fluid CA is flowable.

The tank 26 is a pressure container that stores the fluid CA.

The pipe 27 connects the tank 26 and the pump 24 between which the fluid CA is flowable.

When the fluid CA is air, the fluid controller 20 may not include the tank 26 or the pipe 27. In this case, the pump 24 can discharge the air in the bag 40 to the outside of the gripper 30. In this case, the pump 24 can draw air outside the gripper 30 into the bag 40.

### Bag 40

As described above, the bag 40 is a round bottom container with a narrower portion supported by the cover 34 attached to the support 13. The bag 40 includes a body 42 and a pressure sensing portion 50.

As shown in FIG. 1, the body 42 is a hollow bag that is a round bottom container with a narrower portion supported by the cover 34. The body 42 has a substantially U-shaped cross section that is narrower near the opening. The axial direction of the body 42 that is a round bottom container with a narrower portion is hereafter referred to as the longitudinal direction of the bag 40.

The body 42 is formed from an elastomer molded into a thin-walled membrane. The elastomer may be, for example, ethylene propylene diene rubber (EPDM), acrylic rubber (ACM), nitrile rubber (NBR), fluoro rubber (FKM), chloroprene rubber, silicone rubber, or urethane rubber. The elastomer may be piezoelectric rubber. Piezoelectric rubber will be described in detail later.

The body 42 includes the neck 44, the receiving portion 46, and a distal end 47.

The neck 44 is an open end of the body 42 that is a bag being a round bottom container with a narrower portion. The neck 44 includes a narrower portion of the body 42 that is a round bottom container with a narrower portion.

In the body 42 that is a round bottom container with a narrower portion, the receiving portion 46 is closer to the bottom than the neck 44 is. The receiving portion 46 connects to the neck 44. The receiving portion 46 is substantially spherical. The receiving portion 46 can receive the mixture CM (described later).

The distal end 47 is an end of the receiving portion 46 opposite to the neck 44. When the gripper 30 in the embodiment grips the article MO, the distal end 47 is closest to the article MO than other parts of the body 42 are.

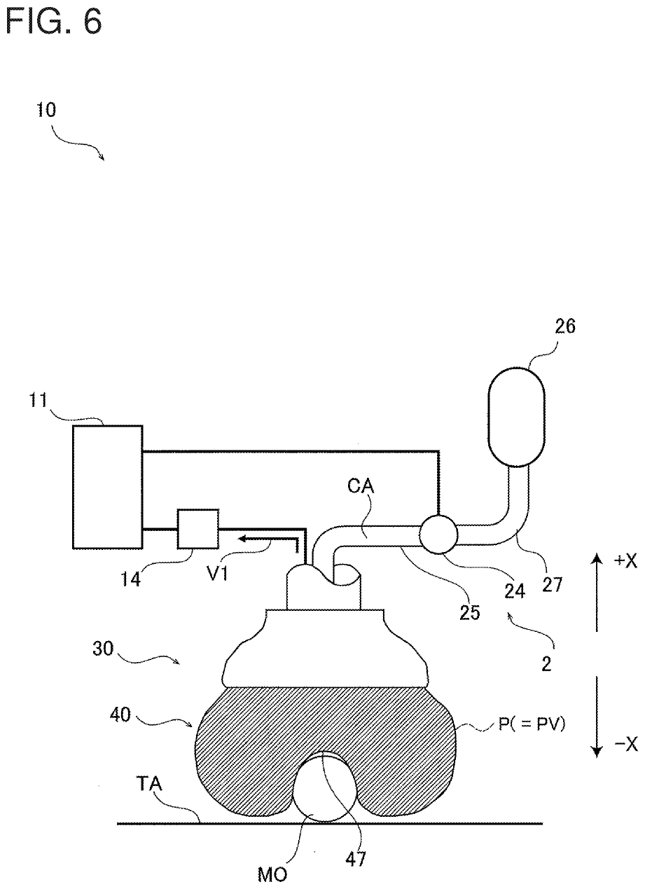

When the mixture CM is fluid-like, the body 42 (specifically, the receiving portion 46) in contact with the article MO is elastically deformable into a shape with a surface shape conforming to the outer shape (surface shape) of the article MO (refer to FIG. 6). In this case, the bag 40 adheres to the article MO in an adhering state. Being fluid-like refers to being flowable in the bag 40 like a fluid while conforming to the shape of the bag 40 containing the mixture CM. Being solid-like refers to being unflowable in the bag 40.

The pressure sensing portion 50 senses a contact pressure resulting from contact between the body 42 and the article MO to output a voltage to the detector 14. In other words, the pressure sensing portion 50 exhibits piezoelectric effect. The bag 40 including the pressure sensing portion 50 can sense a contact pressure resulting from contact with the article MO to output a voltage to the detector 14. The pressure sensing portion 50 does not obstruct elastic deformation of the body 42.

The pressure sensing portion 50 is, for example, the body 42 formed from piezoelectric rubber. The piezoelectric rubber is an elastomer that exhibits piezoelectric effect. The piezoelectric rubber includes a piezoelectric material and a rubber base material.

The piezoelectric material is a granular material that exhibits piezoelectric effect. The piezoelectric material include, for example, lead zirconate titanate, barium titanate, lithium niobate, lead titanate, lead metaniobate, polyvinylidene fluoride, or crystal.

The rubber base material is an elastomer holding the piezoelectric material. The rubber base material may contain, for example, nitrile rubber, fluorine rubber, chloroprene rubber, silicone rubber, or urethane rubber.

The piezoelectric rubber may be formed with the method described in, for example, Japanese U.S. Pat. No. 5,046,367, Japanese Unexamined Patent Application Publication No. 60-120579, or Japanese Unexamined Patent Application Publication No. 54-157297.

When the pressure sensing portion 50 is the body 42 formed from the piezoelectric rubber, the body 42 includes a terminal 50a as shown in FIG. 1. The terminal 50a outputs a voltage generated by the piezoelectric effect of the body 42 formed from the piezoelectric rubber. The terminal 50a is connected to the detector 14 as shown in FIG. 1. In this case, the bag 40 is connected to the detector 14 with the terminal 50a between the bag 40 and the detector 14 as shown in FIG. 2.

The terminal 50a in the embodiment is contained in, as shown in FIG. 1, the base 32 that is a box. The terminal 50a in one or more embodiments of the present disclosure may be located on an outer surface of a part of the body 42 that does not come in contact with the article MO.

The pressure sensing portion 50 may be a piezoelectric film 52. The piezoelectric film 52 is a membrane that exhibits piezoelectric effect. The piezoelectric film 52 is flexible. The piezoelectric film 52 may contain, for example, vinylidene fluoride, tetrafluoroethylene, trifluoroethylene, a polyamino acid material, or a cellulose derivative.

The piezoelectric film 52 may be a layered film held between flexible sheets. The piezoelectric film 52 held between the sheets may be formed with, for example, the method described in Japanese Unexamined Patent Application Publication No. 2011-222679, Japanese Unexamined Patent Application Publication No. 2020-119995, or International Publication No. WO 2022/091829.

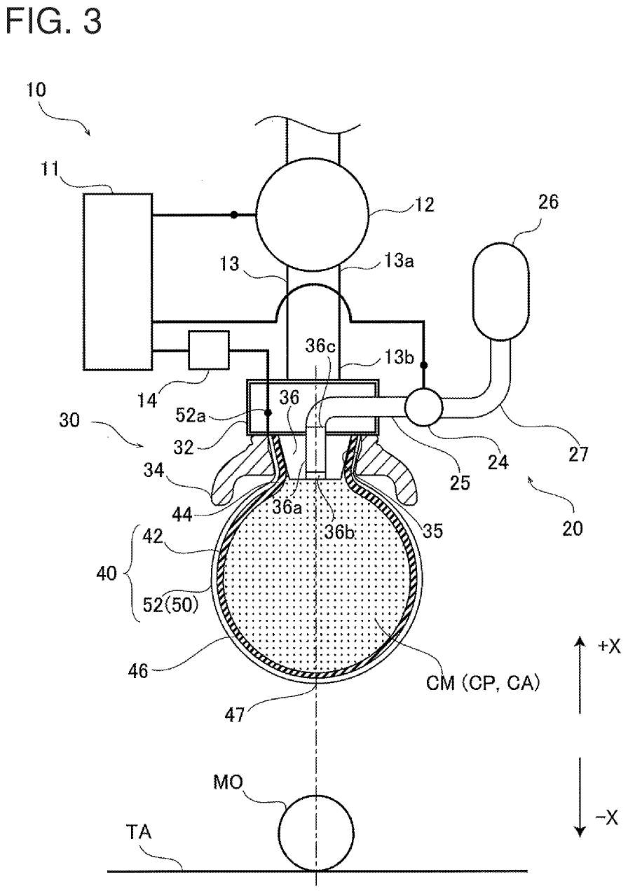

The piezoelectric film 52 covers an outer surface of the body 42 as shown in FIG. 3. The piezoelectric film 52 is fixed to the body 42 with, for example, an adhesive or a piece of tape. In FIG. 3, the piezoelectric film 52 is illustrated with a space between the piezoelectric film 52 and the body 42 for ease of illustration.

The piezoelectric film 52 is elastically deformable along the surface shape of the body 42. When the bag 40 comes in contact with the article MO, the body 42 coming in contact with the article MO with the piezoelectric film 52 between the body 42 and the article MO deforms elastically. In this case, the piezoelectric film 52 elastically deforms together with the body 42.

The piezoelectric film 52 includes a terminal 52a. The terminal 52a outputs the voltage generated by the piezoelectric effect of the piezoelectric film 52. The terminal 52a is connected to the detector 14 as shown in FIG. 3. In this case, the bag 40 is connected to the detector 14 with the terminal 52a between the bag 40 and the detector 14 as shown in FIG. 2.

The terminal 52a in the embodiment is contained in, as shown in FIG. 3, the base 32 that is a box. The terminal 52a may be located on an outer surface of a part of the bag 40 that does not come in contact with the article MO.

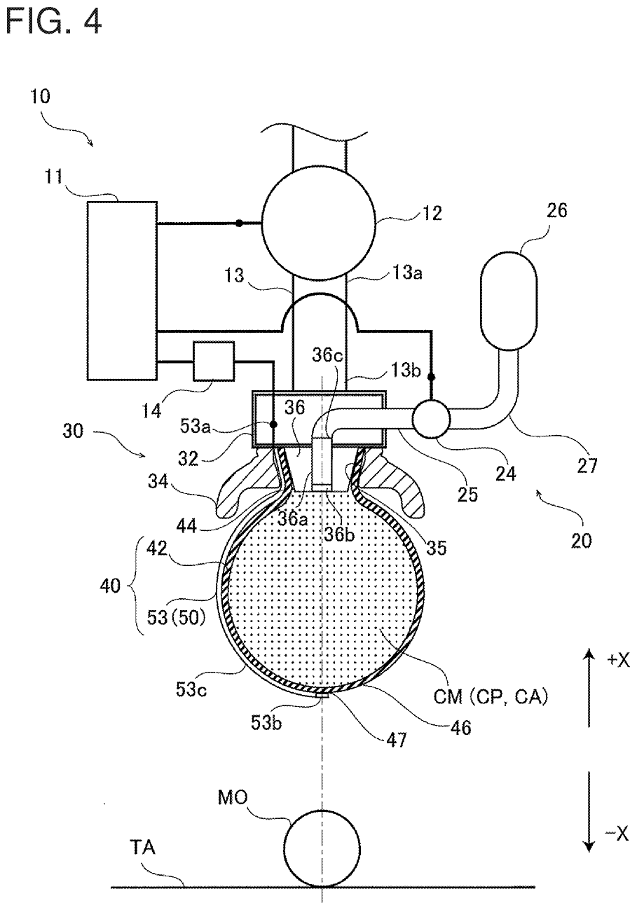

The pressure sensing portion 50 may be a pressure sensor 53. The pressure sensor 53 is a band that exhibits piezoelectric effect. The pressure sensor 53 is flexible. The pressure sensor 53 extends along the outer surface of the body 42 as shown in FIG. 4. The pressure sensor 53 includes a band 53c, an element 53b, and a terminal 53a.

The band 53c extends from the distal end 47 to the neck 44 along the body 42. The band 53c is flexible. The band 53c includes a conducting wire and a coating (not shown).

The conducting wire extends in the longitudinal direction of the band 53c. The conducting wire allows a current to flow between two ends of the band 53c.

The coating covers and protects the surface of the conducting wire.

The band 53c may be a layered band with the conducting wire held between coatings.

The element 53b is a piezoelectric element that exhibits piezoelectric effect. The element 53b at least comes in contact with the article MO when the gripper 30 grips the article MO. The element 53b in the embodiment is at an end of the band 53c adjacent to the distal end 47. The element 53b may be protected with a coating 53e. The pressure sensor 53 in one or more embodiments of the present disclosure may include, in the longitudinal direction of the band 53c, multiple elements 53b attached to portions of the conducting wire 53d at predetermined intervals.

The element 53b may overlap the distal end 47 of the body 42 as shown in FIG. 4. The element 53b may be spaced from the distal end 47.

The terminal 53a outputs a voltage generated by the piezoelectric effect of the element 53b. The terminal 53a in the embodiment is attached to an end of the band 53c adjacent to the neck 44. The terminal 53a is connected to the detector 14 as shown in FIG. 4. In this case, the bag 40 is connected to the detector 14 with the terminal 53a between the bag 40 and the detector 14 as shown in FIG. 2.

The terminal 53a in the embodiment is contained in, as shown in FIG. 4, the base 32 that is a box. The terminal 53a may be located on an outer surface of a part of the bag 40 that does not come in contact with the article MO.

The bag 40 shown in FIG. 4 includes a single pressure sensor 53. When the pressure sensing portion 50 is the pressure sensor 53, the bag 40 may include multiple pressure sensors 53. In this case, the multiple pressure sensors 53 extend radially about the distal end 47 of the body 42 in directions parallel to the radial directions and toward the neck 44 along the outer surface of the body 42.

As shown in FIGS. 1, 3, and 4, the mixture CM is contained in the receiving portion 46 of the bag 40. The mixture CM at least includes particles CP. The mixture CM may include the fluid CA.

The particles CP may have a particle size of 0.1 to 4 mm. The particles CP are, for example, ground coffee. The particles CP may be rice grains, glass beads, sawdust, or diatomite.

The fluid CA is, for example, a gas such as air. The fluid CA may be a liquid such as water.

The mixture CM contained in the bag 40 can undergo a pseudo phase transition (jamming transition) between a fluid-like state and a solid-like state under control of the fluid controller 20 controlling the amount of the fluid CA. In other words, the mixture CM contained in the bag 40 can undergo a pseudo phase transition (jamming transition) between a fluid-like state and a solid-like state under control of the fluid controller 20 controlling the pressure of the fluid CA in the bag 40.

More specifically, the fluid-like mixture CM contained in the bag 40 includes the particles CP and the fluid CA. The particles CP define spaces between the particles CP. The fluid CA fills the spaces defined by the particles CP. When an external force is applied to the bag 40 in this state, the mixture CM flows to conform to the deformation of the bag 40 receiving the external force. In other words, the bag 40 with the fluid-like mixture CM is flexibly deformable under the external force. The bag 40 in this state is in a softened state.

The fluid controller 20 is operated to cause the bag 40 containing the mixture CM including the particles CP and the fluid CA to discharge the fluid CA. The particles CP then adhere to one another. This eliminates the spaces defined in the fluid-like state. In this case, the mixture CM includes the particles CP alone. In this case, the mixture CM transitions from a fluid-like state to a solid-like state. In one or more embodiments of the present disclosure, transitioning refers to undergoing a pseudo phase transition. In other words, when the fluid controller 20 reduces the pressure in the bag 40 containing the mixture CM including the particles CP and the fluid CA, the mixture CM transitions from a fluid-like state to a solid-like state.

In this state, the solid-like mixture CM reduces deformation of the bag 40 when an external force is applied to the bag 40. In other words, the bag 40 containing the solid-like mixture CM is hardened with the mixture CM. The bag 40 in this state is in a hardened state.

When the fluid controller 20 reduces the pressure in the bag 40 containing the mixture CM including the particles CP and the fluid CA, the bag 40 shifts from the softened state to the hardened state.

When the fluid controller 20 is operated to cause the fluid CA to flow into the bag 40 containing the solid-like mixture CM, the mixture CM includes the fluid CA and transitions from a solid-like state to a fluid-like state. In other words, when the fluid controller 20 increases the pressure in the bag 40 containing the mixture CM including the particles CP alone, the mixture CM transitions from a solid-like state to a fluid-like state. When the fluid controller 20 increases the pressure in the bag 40 containing the mixture CM including the particles CP alone, the bag 40 shifts from the hardened state to the softened state.

As shown in FIG. 2, the controller 11 is electrically connected to the detector 14, the notifier 15, the gripper 30, and the drive group including the drive 12. As described above, the controller 11 controls the components of the gripping apparatus 10. The controller 11 includes a central processing unit (CPU), a read-only memory (ROM), a random-access memory (RAM), and an interface. The ROM stores programs executable by the CPU. The RAM stores parameters used in the programs executable by the CPU. The interface communicates with devices electrically connected to the controller 11.

The controller 11 includes a storage 11a. The storage 11a is a storage such as a hard disk drive (HDD) or a solid-state drive (SSD). The storage 11a can store information associated with the determiner 11b. The information associated with the determiner 11b includes a reference value VB and a predetermined threshold VC. The threshold VC is preset by an operator (not shown) before the operation of the gripping apparatus 10. The information associated with the determiner 11b includes information transmitted to the notifier 15 based on a determination result from the determiner 11b (described later).

The controller 11 functions as the determiner 11b with a program executed by the CPU. The determiner 11b determines the gripping state of the bag 40. The determiner 11b transmits the determination result of the gripping state of the bag 40 to the notifier 15.

The operation of the controller 11 will be described in detail together with the operation of the gripping apparatus 10 and a method for determining the gripping state described below.

### Method for Determining Gripping State

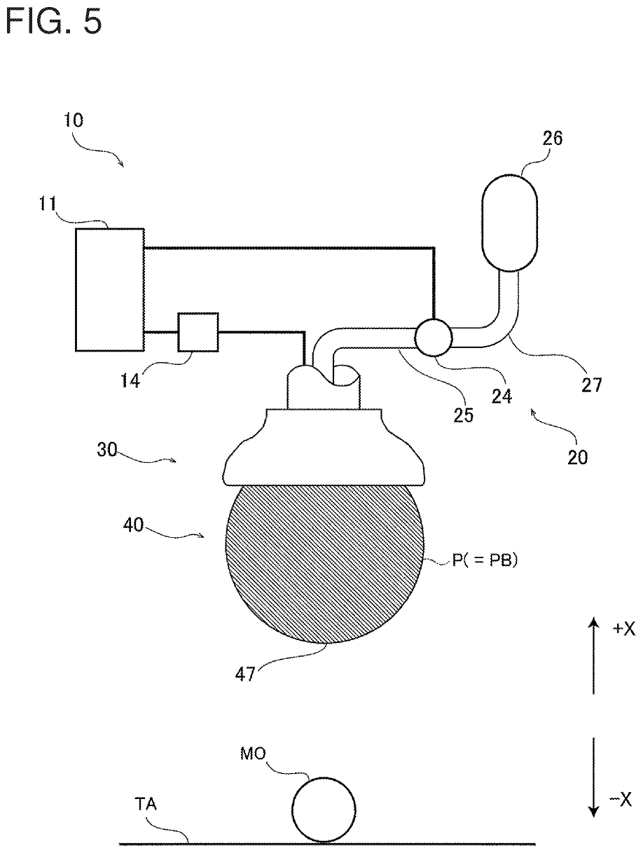

An operation of the gripping apparatus 10 that grips the article MO located on the table TA with the gripper 30 and then transfers the article MO from the table TA to another table to place the article MO and a method for determining the gripping state will now be described with reference to FIGS. 5 to 9. The other table is at a preset position.

As shown in FIG. 5, the gripper 30 is vertically upward from the article MO on the table TA. In this case, the bag 40 contains the mixture CM including the particles CP and the fluid CA. In this case, the mixture CM is fluid-like. The pressure P in the bag 40 has a value of PB.

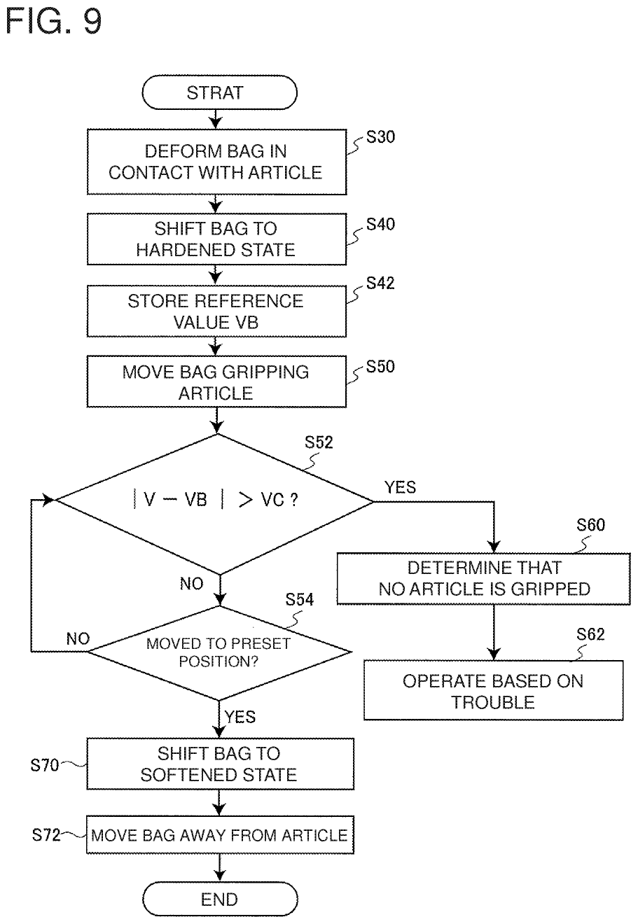

The controller 11 then controls the drive group to move the gripper 30 vertically downward to cause the bag 40 to come in contact with the article MO and receive the article MO embedded as shown in FIG. 6. In this case, the bag 40 elastically deforms while conforming to the outer shape of the article MO in the adhering state (step S30 in FIG. 9). The pressure sensing portion 50 is not in contact with the table TA. In other words, the bag 40 may not come in contact with the table TA. In this case, the bag 40 in contact with the article MO outputs a voltage V from the pressure sensing portion 50 to the detector 14. The detector 14 detects the value of the voltage V, and transmits the value to the controller 11.

The controller 11 then controls the fluid controller 20 and causes the fluid CA to be discharged from the bag 40 in the adhering state. In other words, the controller 11 controls the fluid controller 20 while maintaining the adhering state of the bag 40 and causes the pressure of the mixture CM in the bag 40 (step S40) to decrease as shown in FIG. 9. In this case, the pressure P in the bag 40 is PV. In this case, the mixture CM in the bag 40 transitions from a fluid-like state to a solid-like state. In this case, the bag 40 can grip the article MO and perform transferring such as handling in a gripping state. In this case, the voltage V output from the bag 40 to the detector 14 is V1. The controller 11 stores the value of the voltage V1 transmitted from the detector 14 in step S40 into the storage 11a as the reference value VB (step S42).

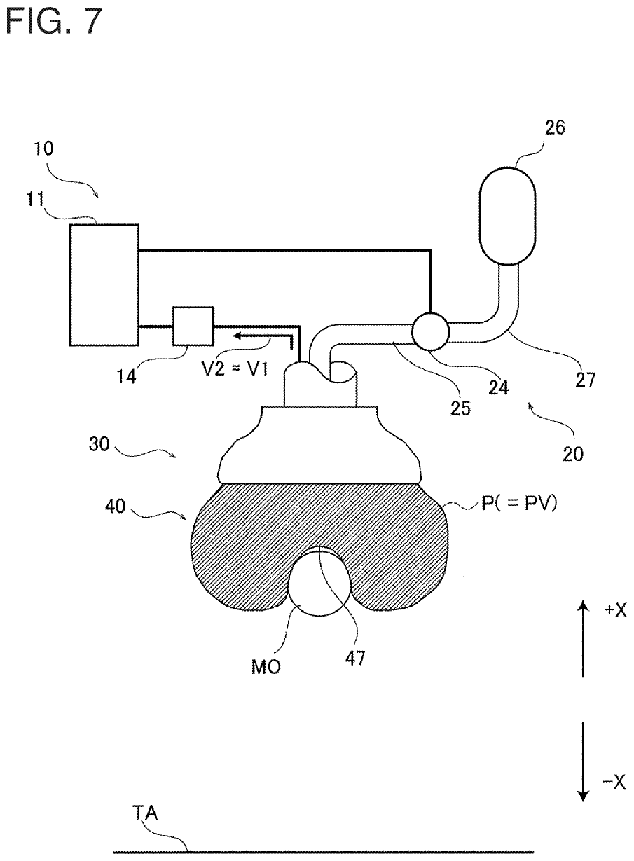

The controller 11 then controls the drive group and causes the gripper 30 gripping the article MO to move vertically upward and lift the article MO from the table TA as shown in FIG. 7. The controller 11 further controls the drive group and causes the gripper 30 gripping the article MO to move to a preset position. In other words, the controller 11 causes the bag 40 gripping the article MO to move from the table TA to the preset position (step S50).

In a transfer period in which the bag 40 gripping the article MO moves from the table TA to the preset position, the determiner 11b determines the gripping state of the bag 40 based on the value of the voltage V output from the bag 40 and the reference value VB stored in the storage 11a. More specifically, the determiner 11b determines whether the difference between the voltage V output from the bag 40 and the reference value VB exceeds the threshold VC stored in the storage 11a (step S52).

In the transfer period in which the gripping apparatus 10 transfers the article MO, the bag 40 outputs a voltage V that is substantially equal to the voltage V1 in step S40 while the gripper 30 is gripping the article MO as shown in FIG. 7. In this case, the voltage V output from the bag 40 is V2 (≈V1) with a difference from the voltage V1 because of, for example, vibrations of the drive group operating to transfer the article MO. The difference between the voltage V2 output from the bag 40 and the reference value VB is smaller than the threshold VC (|V2−VB|≤VC). In this case, the determiner 11b determines that the gripper 30 gripping the article MO maintains the gripping state in step S52.

The controller 11 subsequently determines whether the bag 40 has moved to the preset position based on the state of the drive group (step S54). When the bag 40 has not moved to the preset position, the processing returns to step S52. Steps S52 and S54 are repeated at predetermined time intervals until the bag 40 moves to the preset position.

When the bag 40 moves to the preset position, the controller 11 further controls the drive group and causes the gripper 30 to move toward another table to place the gripped article MO onto the other table at the preset position. The controller 11 then controls the fluid controller 20 and causes the fluid CA to flow into the bag 40. In other words, the controller 11 controls the fluid controller 20 and causes the pressure of the mixture CM in the bag 40 to increase (step S70). In this case, the mixture CM in the bag 40 transitions from a solid-like state to a fluid-like state. This resets the gripping state of the bag 40 that grips the article MO. The article MO is then released from the gripper 30.

The controller 11 then controls the drive group and causes the bag 40 to move away from the article MO (step S72).

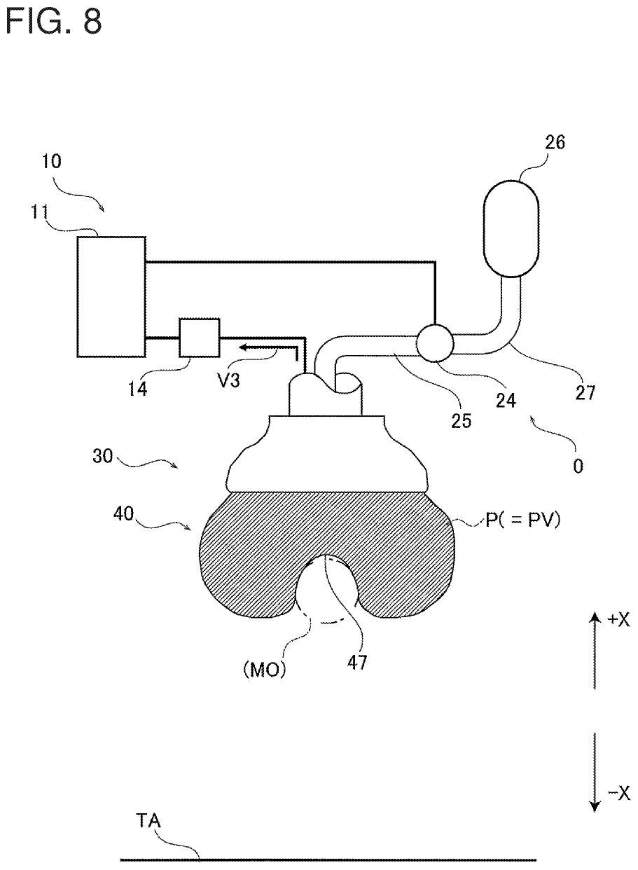

An operation in response to a trouble such as the bag 40 dropping the article MO in the transfer period in which the gripping apparatus 10 transfers the article MO in step S50 will be described. As shown in FIG. 8, the bag 40 outputs a voltage V3 when the gripper 30 grips no article MO. With the pressure sensing portion 50 of the bag 40 not in contact with the article MO, the voltage V3 output from the bag 40 differs from the voltage V1 output in the gripping state. In this case, the difference between the voltage V3 output from the bag 40 and the reference value VB is greater than the threshold VC (|V3−VB|>VC). In this case, the determiner 11b determines, in step S52, that the gripper 30 grips no article MO (step S60).

In this manner, the controller 11 determines the gripping state of the bag 40 based on whether the difference between the voltage V output from the bag 40 in the hardened state and the reference value VB exceeds the predetermined threshold VC.

The controller 11 subsequently controls the operations of the components of the gripping apparatus 10 based on the occurrence of a trouble (step S62). More specifically, the controller 11 causes the notifier 15 to provide an alert indicating the occurrence of a trouble. The controller 11 controls the drive group and causes the gripper 30 to stop moving toward the other table.

In the transfer period in which the gripping apparatus 10 transfers the article MO in step S50, when the bag 40 gripping the article MO is in trouble and collides with, for example, another member, the bag 40 outputs a voltage V4. The voltage V4 output from the bag 40 is a value different from the voltage V1 output from the bag 40 in contact with the article MO alone in the gripping state. In this case, the difference between the value of the voltage V4 output from the bag 40 and the reference value VB is greater than the threshold VC (|V4−VB|>VC). In this case, the determiner 11b determines, in step S52, that the gripper 30 in the gripping state is in trouble. The controller 11 then controls the operations of the components of the gripping apparatus 10 based on the occurrence of the trouble as in step S62.

### Advantages and Effects

The advantages and effects of the gripping apparatus 10 will now be described.

The bag 40 in the gripping apparatus 10 including the pressure sensing portion 50 is elastically deformable in conformance with the outer shape of the article MO and can sense a contact pressure resulting from contact with the article MO to output a voltage to the detector 14. The pressure sensing portion 50 does not obstruct elastic deformation of the body 42 unlike a mechanical apparatus such as a push button. The gripping apparatus 10 achieves a gripping apparatus using the jamming transition to grip an article MO that can determine the gripping state for the article MO with a simple structure.

With the method for determining the gripping state performed by the controller 11, the gripping state of the bag 40 is determined based on whether the difference between the value of the voltage V output from the bag 40 in the hardened state and the reference value VB exceeds the predetermined threshold VC. With the method for determining the gripping state performed by the gripping apparatus 10, the gripping state of the bag 40 using the jamming transition to grip an article MO can be determined based on the voltage V output from the bag 40.

One method for determining the gripping state of the gripper 30 that grips the article MO is detecting a change in the weight of the gripper 30 caused by the gripped article MO with a load cell included in the base 32 or the support 13. When the gripper 30 gripping the article MO changes its orientation three-dimensionally, the direction of the relative load of the weight of the article MO on the gripper 30 and the support 13 changes based on the orientation of the gripper 30. In an operation in which the gripper 30 gripping the article MO changes the orientation three-dimensionally, the gripper 30 or the support 13 is to include multiple load cells to determine the gripping state of the gripper 30 with the load cells. In contrast, the method for determining the gripping state according to the embodiment determines the gripping state of the gripper 30 that grips the article MO based on the voltage V output from the pressure sensing portion 50 of the bag 40. Thus, a determination system using the determination method according to the embodiment does not involve multiple pressure sensing portions 50 to address three-dimensional changes in the orientation of the gripper 30.

One method for determining the gripping state of the gripper 30 that grips the article MO uses an optical device such as a camera or an optical sensor to optically or visually determine the state of the gripper 30. However, a determination system using the method for determining the state of the gripper 30 with an optical device has a complex structure. In contrast, the method for determining the gripping state according to the embodiment determines the gripping state of the gripper 30 that grips the article MO based on the voltage V output from the bag 40. A determination system using the determination method according to the embodiment thus has a simple structure.

The determination system using the method for determining the gripping state according to the embodiment can thus simplify the structure of a system for determining the gripping state of the gripper 30 that grips the article MO.

Although the embodiments are described above as examples of the present invention, the present invention is not limited to the above embodiments, and may be altered, changed, or modified in various manners within the scope of its technical idea.

The piezoelectric film 52 and the pressure sensor 53 extend along the outer surface of the body 42. However, the piezoelectric film 52 and the pressure sensor 53 in one or more embodiments of the present disclosure may be inside a membrane of the membranous body 42. In this case, the body 42 may be integral with the piezoelectric film 52 or the pressure sensor 53 as a base material.

1. A gripping apparatus for gripping an article, the apparatus comprising:
a drive;
a support operable by the drive;
a detector configured to detect a voltage;
a bag attached to the support, the bag comprising an elastomer and being elastically deformable in conformance with an outer shape of the article, the bag being configured to sense a contact pressure resulting from contact with the article to output a voltage to the detector;
a mixture contained in the bag, the mixture comprising particles and a fluid; and
a pressure regulator configured to regulate a pressure of the fluid contained in the bag while maintaining a shape of the bag.

2. The gripping apparatus according to claim 1, further comprising:
a controller;
a storage; and
a determiner,
wherein the controller controls the drive and causes the bag to come in contact with the article and to deform elastically while conforming to the outer shape of the article in an adhering state and output a voltage,
the controller controls the pressure regulator to cause a pressure of the mixture to decrease while maintaining the adhering state of the bag to cause a jamming transition of the mixture and cause a shift of the bag from a softened state to a hardened state to grip the article,
the storage stores, as a reference value, a value of a voltage output from the bag when the bag shifts from the softened state to the hardened state, and
the determiner determines a gripping state of the bag based on whether a difference between a value of a voltage output from the bag in the hardened state and the reference value exceeds a predetermined threshold.

3. The gripping apparatus according to claim 1, wherein
the bag comprises piezoelectric rubber.

4. The gripping apparatus according to claim 1, wherein
the bag includes
a body comprising an elastomer, and
a piezoelectric film on an outer surface of the body.

5. The gripping apparatus according to claim 1, wherein
the bag includes
a body comprising an elastomer, and
a pressure sensor extending along an outer surface of the body, the pressure sensor being a band elastically deformable along a surface shape of the body.

6. The gripping apparatus according to claim 2, wherein
the bag comprises piezoelectric rubber.

7. The gripping apparatus according to claim 2, wherein
the bag includes
a body comprising an elastomer, and
a piezoelectric film on an outer surface of the body.

8. The gripping apparatus according to claim 2, wherein
the bag includes
a body comprising an elastomer, and
a pressure sensor extending along an outer surface of the body, the pressure sensor being a band elastically deformable along a surface shape of the body.

9. A method for determining a gripping state, the method comprising:
causing a bag to come in contact with an article and to deform elastically while conforming to an outer shape of the article in an adhering state and output a voltage, the bag containing a mixture of particles and a fluid, the bag containing a predetermined amount of the fluid;
reducing a pressure of the mixture while maintaining the adhering state of the bag to cause a jamming transition of the mixture and cause a shift of the bag from a softened state to a hardened state to grip the article;
storing, as a reference value, a value of a voltage output from the bag when the bag shifts from the softened state to the hardened state; and
determining a gripping state of the bag based on whether a difference between a value of a voltage output from the bag in the hardened state and the reference value exceeds a predetermined threshold.
